(19) United States
(12) Patent Application Publication
(10) Pub. No.: US 2006/0017830 A1
(43) Pub. Date: Jan. 26, 2006

(54) ACTIVE PIXEL SENSOR WITH ISOLATED PHOTO-SENSING REGION AND PERIPHERAL CIRCUIT REGION

(76) Inventor: Chih-Cheng Hsieh, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/904,572

(22) Filed: Nov. 17, 2004

(30) Foreign Application Priority Data
Jul. 23, 2004 (TW) 093122116

(51) Int. Cl. H04N 5/335

(52) U.S. Cl. 348/308

(57) ABSTRACT

An active pixel sensor includes a substrate, a photo-sensing region, a peripheral circuit region, and an isolation region. The photo-sensing region and the peripheral circuit region are formed on the substrate. The isolation region is formed between the photo-sensing region and the peripheral circuit region for isolating the photo-sensing region and the peripheral circuit region. The photo-sensing region induces photo current according to the received light. The peripheral circuit region includes a first transistor having a source connected to a bit line, a second transistor having a gate connected to the photo-sensing region, a source connected to the drain of the first transistor and a drain connected to a voltage source, and a third transistor having a source connected to the photo-sensing region and a drain connected to the voltage source.

### BACKGROUND OF INVENTION

1. Field of the Invention

The present invention relates to an active pixel sensor with an isolated photo-sensing region and peripheral circuit region, and more particularly, to an active pixel sensor which can reduce dark current leakage and increase the fill factor.

2. Description of the Prior Art

A complementary metal-oxide-semiconductor (CMOS) image sensor is a common solid-state image sensor. Since a CMOS image sensor device is produced by conventional semiconductor techniques, the CMOS image sensor has advantages of low cost and reduced device size. In addition, the CMOS image sensor further has advantages of high quantum efficiency and low read-out noise. The CMOS image is therefore commonly used in photoelectric products, such as PC cameras and digital cameras.

Please refer to FIG. 1 and FIG. 2. FIG. 1 is a diagram of the prior art active pixel sensor 10 of CMOS image sensor device. FIG. 2 is the circuit of the active pixel sensor 10 of FIG. 1. Active pixel sensor 10 comprises a photo diode D1 for sensing the light, and three metal-oxide semiconductor (MOS) transistors M1˜M3, including a row selector M1, a source follower M2, and a reset MOS M3. The photo diode D1 induces photo current according to the light received from the photo-sensing region. The row selector M1 is used to select whether to output the voltage signal integrated by the photo diode D1 or not. The output of the source follower M2 is modulated according to the charge of the photo diode D1. The reset MOS M3 is used to reset the photo diode D1; that is, when the reset MOS M3 is “on”, the voltage of the photo diode D1 is retained at a constant voltage, which does not change with the light received from the photo-sensing region. On the other hand, when the reset MOS M3 is “off”, the voltage of the photo diode D1 changes with the light received from the photo-sensing region.

The active pixel sensor 10 is produced by conventional semiconductor techniques. It has advantages of low cost and reduced device size. However, the drawbacks are that current leakage occurs in the high slope area of the diffusion region between the reset MOS M3 and the photo diode D1 and that the fill factor is reduced. Generally, a high fill factor represents higher photo-sensitivity. The equation of fill factor is as follows:

$$ff = \frac{Av}{A} \times 100 \%$$

where ff represents the fill factor;

A represents the entire area of the active pixel sensor; and

Av represents the area of the photo-sensing region.

The current leakage occurs at the connection between the depletion region and the isolation region. The problems of current leakage and reducing the fill factor are discussed as follows.

Please refer to FIG.3. FIG. 3 is a cross sectional diagram along line 3-3 ′ of the active pixel sensor 10 of FIG. 1. The prior art photo diode D1 includes a P-type substrate 12, an N− doped region 16, an N+ doped region 18, and a shallow trench isolation (STI) 20. There is a depletion region 14 between the P-type substrate 12 and the N− doped region 16. When the depletion region 14 contacts the flat area of the STI 20, current leakage is small due to well oxide surface control. As shown in FIG. 3, current leakage is small at the part along line 3-3′ of the active pixel sensor 10.

Please refer to FIG. 4. FIG. 4 is a cross sectional diagram along line 4-4 ′ of the active pixel sensor 10 of FIG. 1. One end of the depletion region 14 contacts the N+ doped region 18 and the other end of the depletion region 14 contacts the flat area of the STI 20. The current leakage is small because the depletion region 14 does not contact the high slope area of the STI 20.

Please refer to FIG. 5 and FIG. 6. FIG. 5 is a cross sectional diagram along line 5-5′ of the active pixel sensor 10 of FIG. 1. FIG. 6 is a three dimensional diagram of the active pixel sensor 10 of FIG. 5. As shown in FIG. 6, one end of the depletion region 14 strides across the high slope area of the STI 20 (as the high slope area 15 in FIG. 5), a PN junction therefore is formed. The markable current leakage occurs in the PN junction.

Please refer to FIG. 3 and FIG. 4 again. The cross sectional diagram of the part above line 5-5′ is shown as FIG. 3 while the cross sectional diagram of the part below line 5-5′ is shown as FIG. 4. Therefore, the PN junction is formed in the high slope area 15 of the STI 20 in the left side of FIG. 5 to cause large current leakage.

Large dark current leakage will induce a large fixed pattern noise (FPN) in low light condition and suffer the image quality.

Please refer to FIG. 7 and FIG. 8. FIG. 7 is a diagram of the active pixel sensor 30 that can improve the dark current leakage. FIG. 8 is a cross sectional diagram along line 8-8′ of the active pixel sensor 30 of FIG. 7. In FIG. 8, the two ends of the depletion region 14 both contact the N+ doped region 18 so that the depletion region 14 does not stride across the high slope area of the STI 20 to form the PN junction. This avoids generating markable current leakage, but reduces the fill factor. Please refer to FIG. 7. The two ends of the depletion region 14 both contact the N+ doped region 18. Therefore, the area of the photo-sensing region of FIG. 7 surrounded by the dotted line is smaller than that of FIG. 1. In other words, the fill factor of FIG. 7 is smaller than that of FIG. 1. That is, the fill factor of the active pixel sensor 30 is reduced. Although the active pixel sensor 30 improves dark current leakage, the fill factor of the active pixel sensor 30 is reduced.

As mentioned above, the fill factor of the active pixel sensor 10 of FIG. 1 is larger. However, there is a large current leakage occurring in the diffusion region between the reset MOS M3 and the photo diode D1, as shown in FIG. 5. The active pixel sensor 30 solves the problem of current leakage, but the fill factor of the active pixel sensor 30 is reduced. Therefore, a solution is needed to solve the problem of the current leakage while promoting the fill factor.

### SUMMARY OF INVENTION

It is therefore a primary objective of the claimed invention to provide an active pixel sensor with isolated photo-sensing region and peripheral circuit region to solve the above-mentioned problem.

The present invention discloses an active pixel sensor including a substrate, a photo-sensing region, a peripheral circuit region, and an isolation region. The photo-sensing region and the peripheral circuit region are formed on the substrate. The isolation region is formed between the photo-sensing region and the peripheral circuit region for isolating the photo-sensing region and the peripheral circuit region. The photo-sensing region induces photo current according to the received light. The peripheral circuit region includes a first, second, and third transistors. The first transistor has a source connected to a bit line. The second transistor has a gate connected to the photo-sensing region, a source connected to the drain of the first transistor, and a drain connected to a voltage source. The third transistor has a source connected to the photo-sensing region and a drain connected to the voltage source. The first transistor is used to select whether to output data stored in the photo-sensing region or not. The third transistor is used to reset the photo-sensing region.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a prior art active pixel sensor of a CMOS image sensor device.

FIG. 2 is the circuit of the active pixel sensor of FIG. 1 .

FIG. 3 is a cross sectional diagram along line 3-3′ of the active pixel sensor of FIG. 1.

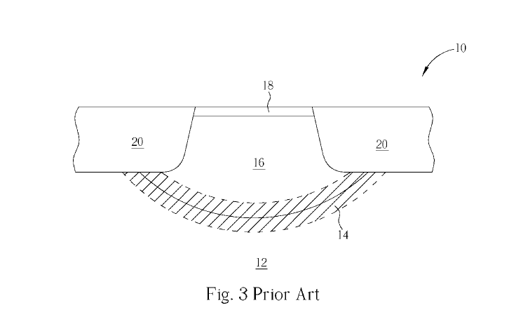

FIG. 4 is a cross sectional diagram along line 4-4′ of the active pixel sensor of FIG. 1.

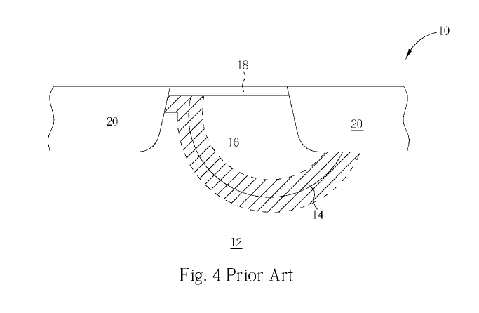

FIG. 5 is a cross sectional diagram along line 5-5′ of the active pixel sensor of FIG. 1.

FIG. 6 is a three dimensional diagram of the active pixel sensor of FIG. 5.

FIG. 7 is a diagram of the active pixel sensor that can solve the problem of current leakage.

FIG. 8 is a cross sectional diagram along line 8-8′ of the active pixel sensor of FIG. 7.

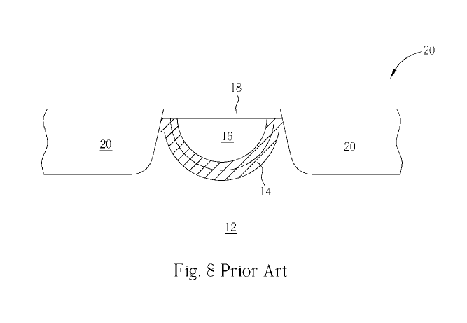

FIG. 9 is a diagram of the active pixel sensor according to the present invention.

### DETAILED DESCRIPTION

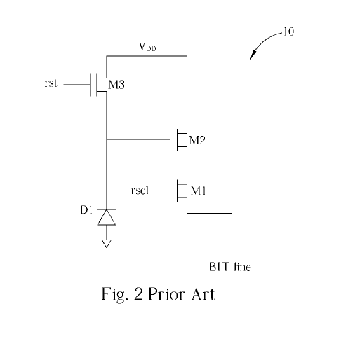

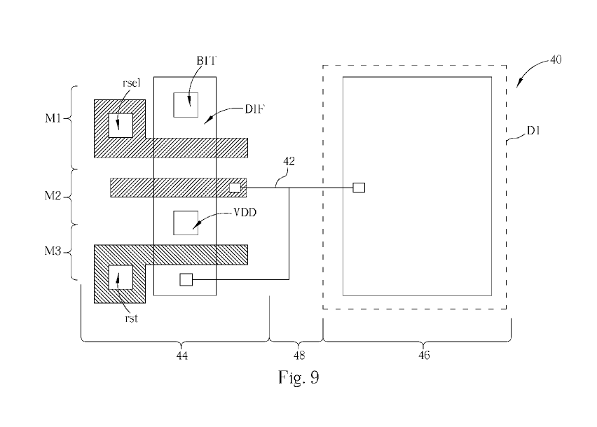

In order to solve the prior art problems, the present invention re-designs the layout of the active pixel sensor of CMOS image sensor device. Please refer to FIG. 9. FIG. 9 is a diagram of the active pixel sensor 40 according to the present invention corresponding to the circuit of FIG. 2. The active pixel sensor 40 includes a substrate 12, a photo-sensing region 46, a peripheral circuit region 44, and an isolation region 48. The photo-sensing region 46, the peripheral circuit 44 and the isolation region 48 are formed on the substrate 12. The isolation region 48 is formed between the photo-sensing region 46 and the peripheral circuit region 44 for isolating the photo-sensing region 46 and the peripheral circuit region 44.

The photo-sensing region 46 includes a first diffusion region 16 formed on the substrate 12, a second diffusion region 18 formed above the first diffusion region 16, and a depletion region 14 formed between the first diffusion region 16 and the substrate 12 for receiving light to induce photo current. The doping concentration of the second diffusion region 18 is greater than the doping concentration of the first diffusion region 16.

The peripheral circuit region 44 includes a first transistor M1, a second transistor M2, and a third transistor M3. The first transistor M1 has a source connected to a bit line. The second transistor M2 has a gate connected to the photo-sensing region 46, a source connected to the drain of the first transistor M1, and a drain connected to a voltage source VDD. The third transistor M3 has a source connected to the photo-sensing region 46 and a drain connected to the voltage source VDD. The first transistor M1 is used to select whether to output data stored in the photo-sensing region 46 or not. The third transistor M3 is used to reset the photo-sensing region 46. The operation of the three transistors M1-M3 is described above thereby omitted herein.

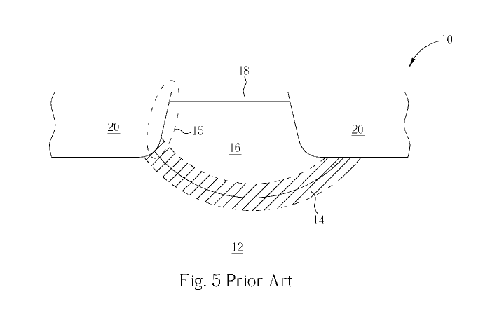

Since the present invention isolates the photo-sensing region 46 and the peripheral circuit region 44, a metal conductor 42 is used for connecting the photo diode D1 to the gate of the second transistor M2 and connecting the photo diode D1 to the source of the third transistor M3. In other words, the gate of the second transistor M2 is connected to the second diffusion region 18 of the photo-sensing region 26 through the metal conductor 42, and the source of the third transistor M3 is connected to the second diffusion region 18 of the photo-sensing region 26 through the metal conductor 42. Compared to the prior art, the prior art uses diffusion connection to connect the third transistor M3 and the photo diode D1, causing current leakage to occur. The present invention uses the metal conductor 42 to connect the source of the third transistor M3 to the second diffusion region 18 of the photo-sensing region 46. Thus, the present invention avoids forming the PN junction in FIG. 5 that generates current leakage.

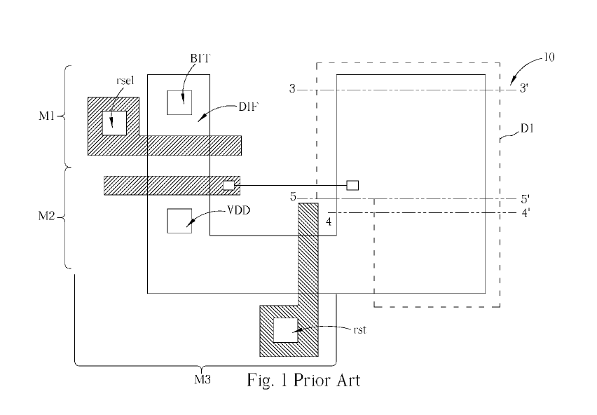

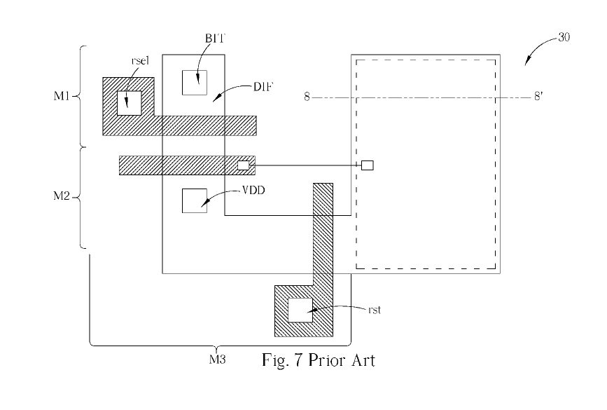

Please refer to FIG. 1, FIG. 7 and FIG. 9 again. According to the new layout of the active pixel sensor 40 of the present invention, the entire area of the photo-sensing region 46 of the photo diode D1 (dotted line in FIG. 9) is greater than those of FIG. 1 and FIG. 7. The present invention therefore can promote the fill factor further to improve the resolution.

In addition, the substrate 12 of the active pixel sensor 40 of the present invention is a P-type substrate; the first and second diffusion regions 16, 18 of the photo-sensing region 46 are N-type regions; and the three transistors M1˜M3 of the peripheral circuit region 44 are NMOS. Please refer to FIG. 2 and FIG. 9. Due to the layout of FIG. 9, the drain of the first transistor M1 and the source of the second transistor M2 coexist in the same doped region, and the drain of the second transistor M2 and the drain of the third transistor M3 coexist in the same doped region. The isolation region 48 formed between the photo-sensing region 46 and the peripheral circuit region 44 is a shallow trench isolation layer (STI) or a field oxide layer (FOX) for isolating the photo-sensing region 46 and the peripheral circuit region 44. In addition to the isolation region 48 between the photo-sensing region 46 and the peripheral circuit region 44, there are isolation regions, which are shallow trench isolation layer or field oxide layer, surrounding the photo-sensing region 46 and the peripheral circuit region 44. Moreover, the embodiment of the present invention uses NMOS for the three transistors M1˜M3. However, the present invention can take other materials such as PMOS for the three transistors M1˜M3 for modifications and alterations.

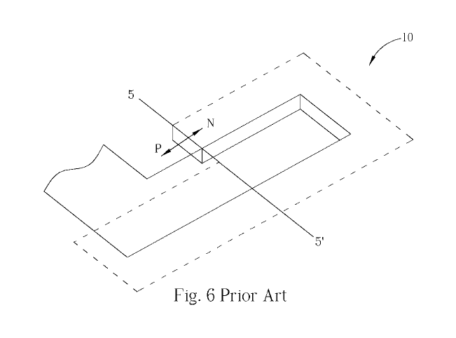

Compared to the prior art, the present invention isolates the photo-sensing region 46 and the peripheral circuit region 44. In other words, the present invention isolates the transistor M3 and the photo diode D1 to solve the prior art current leakage occurring in the diffusion region between the transistor M3 and the photo diode D1 because there is no the PN junction formed between the depletion region and the high slope area of the STI to generate current leakage, as shown in FIG. 5 and FIG. 6. Furthermore, the present invention can enormously promote the fill factor to improve the resolution because the diffusion region is completely within the depletion region.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An active pixel sensor comprising:
a substrate;
a photo-sensing region formed on the substrate for inducing photo current according to received light;
a peripheral circuit region formed on the substrate, the peripheral circuit region including:
a first transistor having a source connected to a bit line, the first transistor being used to select whether to output data stored in the photo-sensing region or not;
a second transistor having a gate connected to the photo-sensing region, a source connected to a drain of the first transistor, and a drain connected to a voltage source; and
a third transistor having a source connected to the photo-sensing region and a drain connected to the voltage source, the third transistor being used to reset the photo-sensing region; and
an isolation region formed between the photo-sensing region and the peripheral circuit region for isolating the photo-sensing region and the peripheral circuit region.

2. The active pixel sensor of claim 1 wherein the photo-sensing region comprises:
a first diffusion region formed on the substrate;
a second diffusion region formed on the first diffusion region, a doping concentration of the second diffusion region being greater than a doping concentration of the first diffusion region; and
a depletion region formed between the first diffusion region and the substrate for receiving light to induce photo current.

3. The active pixel sensor of claim 2 wherein the gate of the second transistor is connected to the second diffusion region of the photo-sensing region by a metal conductor, and the source of the third transistor is connected to the second diffusion region of the photo-sensing region by a metal conductor.

4. The active pixel sensor of claim 2 wherein the substrate is P-type substrate, the first and second diffusion regions are N-type regions, and the three transistors are NMOS.

5. The active pixel sensor of claim 1 wherein the drain of the first transistor and the source of the second transistor coexist in the same doped region, the drain of the second transistor and the drain of the third transistor coexist in the same doped region.

6. The active pixel sensor of claim 1 wherein the isolation region is one of a shallow trench isolation layer and a field oxide layer.
